(19) United States
(12) Patent Application Publication
(10) Pub. No.: US 2011/0025075 A1
(43) Pub. Date: Feb. 3, 2011

(54) WINDOW TILT LATCH

(75) Inventors: James CHANG, Taichung City (TW); Sung-Hui LIN, Taichung City (TW)

Correspondence Address: PATENTTM.US, P. O. BOX 82788, PORTLAND, OR, 97282-0788, US

(73) Assignee: DOOR & WINDOW HARDWARE CO., Taichung City (TW)

(21) Appl. No.: 12/511,422

(22) Filed: Jul. 29, 2009

(51) Int. Cl. E05C 1/10

(52) U.S. Cl. 292/175

(57) ABSTRACT

A window tilt latch has a casing, a latching bolt and a safety device. The latching bolt is mounted slidably in the casing and has a latching end, an inner end and a sliding element. The latching end extends out of the casing. The sliding element is mounted on the latching bolt and is mounted slidably in a guiding slot defined in the casing. The safety device is mounted on the casing and has a control knob mounted rotatably on the casing, selectively abuts with the inner end of the latching bolt to keep the latching bolt from being retracted into the casing. The control knob has an inserting hole selectively aligning with the inner end of the latching bolt to allow the inner end of the latching bolt to be inserted into the inserting hole and to retract the latching bolt into the casing.

### BACKGROUND OF THE INVENTION

1. Field of the Invention

The present invention relates to a window tilt latch, and more particularly to a window tilt latch having a safety device to keep the latch from being unlocked unintentionally.

2. Description of Related Art

With reference to FIGS. 8 to 10, a window tilt latch (70) is mounted on a window (60) and engages a window frame (62) to keep the window (60) at a closed condition. When the window tilt latches (70) on the window (60) are unlocked and disengaged from the window frame (62), the window (60) can be pivoted and opened to allow a user to clean the window (60).

However, the conventional window tilt latch (70) does not have a safety device. When someone, especially to children, arbitrarily pulls a pulling button (74) on the window tilt latch (70), the window tilt latch (70) is easily unlocked and the window (60) is opened unintentionally. The persons near the window (60) are easily hit and injured by the unintentionally opened window (60).

In addition, in a window (60), two tilt latches (70) each having a latching bolt (72) with a reversal latching end (722) should be mounted respectively on two sides of the window (60) to lock with the window frame (62) and hold the window at a closed condition stably. However, the conventional tilt latch (70) does not have a latching bolt (72) with a symmetrical structure, so two tilt latches (70) with different latching bolts (72) having reversal latching ends (722) should be separately manufactured. Accordingly, the cost for manufacturing the conventional tilt latches (70) is high, and to assemble two tilt latches (70) with different directional latching bolts (72) onto a window (60) is troublesome.

To overcome the shortcomings, the present invention tends to provide a window tilt latch to mitigate or obviate the aforementioned problems.

### SUMMARY OF THE INVENTION

The main objective of the invention is to provide a window tilt latch having a safety device to improve the safety of using the window tilt latch and keep anyone from being hit and injured by a window unintentionally.

The window tilt latch has a casing, a latching bolt, a resilient element and a safety device. The casing is hollow and has a top, an open end and a guiding slot defined in the top of the casing. The latching bolt is mounted slidably in the casing and has a latching end, an inner end and a sliding element. The latching end extends out of the open end of the casing. The inner end is opposite to the latching end and mounted in the casing. The sliding element is mounted on the latching bolt and is mounted slidably in the guiding slot. The resilient element is mounted in the casing and is connected to the latching bolt to provide a recoil force to the latching bolt. The safety device is mounted on the casing and comprises a control knob. The control knob is mounted rotatably on the casing, selectively abuts with the inner end of the latching bolt to keep the latching bolt from being retracted into the casing. The control knob has an inserting hole defined in the control knob and selectively aligning with the inner end of the latching bolt to allow the inner end of the latching bolt to be inserted into the inserting hole and to retract the latching end of the latching bolt into the casing.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a window tilt latch in accordance with the present invention;

FIG. 2 is an exploded perspective view of the window tilt latch in FIG. 1;

FIG. 3 is a side view in partial section of the window tilt latch in FIG. 1;

FIG. 4 is an operational side view in partial section of the window tilt latch in FIG. 1 showing the latching bolt being retracted into the casing;

FIG. 5 is an operational side view in partial section of the window tilt latching in FIG. 1 showing the latching bolt being kept from being retracting into the casing by the safety device;

FIG. 6 is an end view in partial section of the window tilt latching in FIG. 1 showing the sliding element being detached from the latching bolt with tools;

FIG. 7 is an operational perspective view of the window tilt latch in FIG. 1; showing the latching bolt being mounted in the casing in a reverse condition;

FIG. 8 is an operational perspective view of a window provided with two conventional window tilt latches in accordance with the prior art;

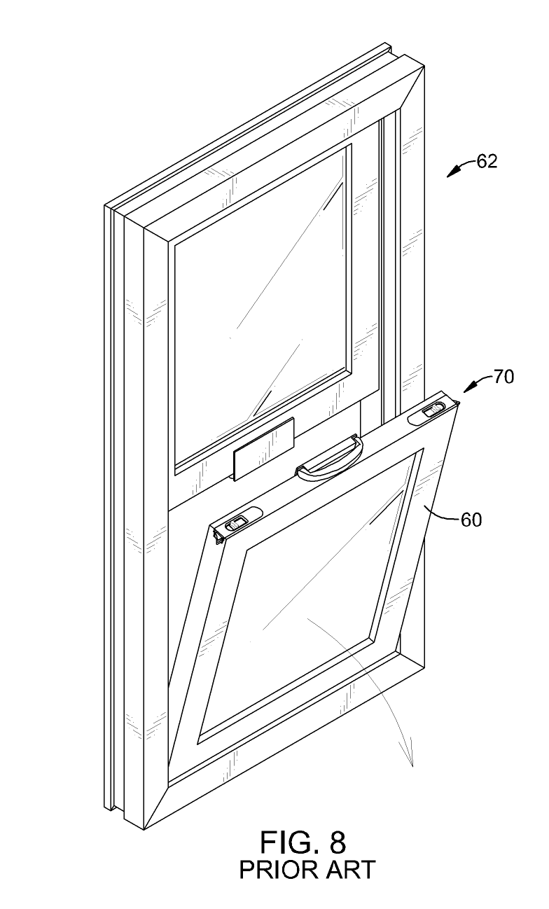

FIG. 9 is a perspective view of the conventional window tilt latch in FIG. 8;

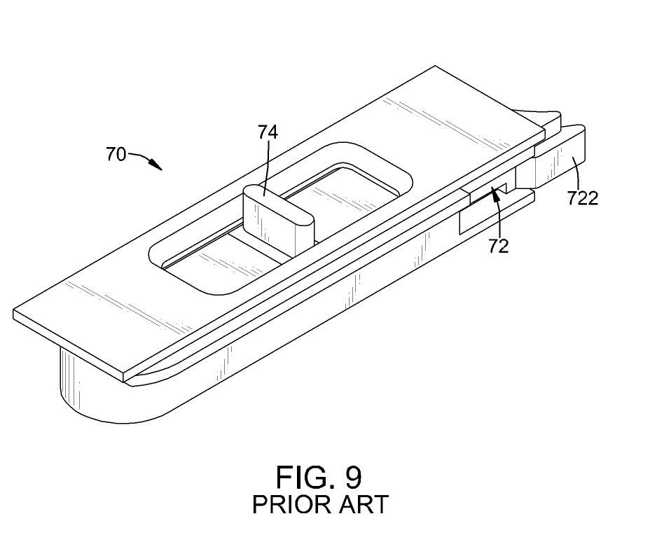

FIG. 10 is an exploded perspective view of the conventional window tilt latch in FIG. 9.

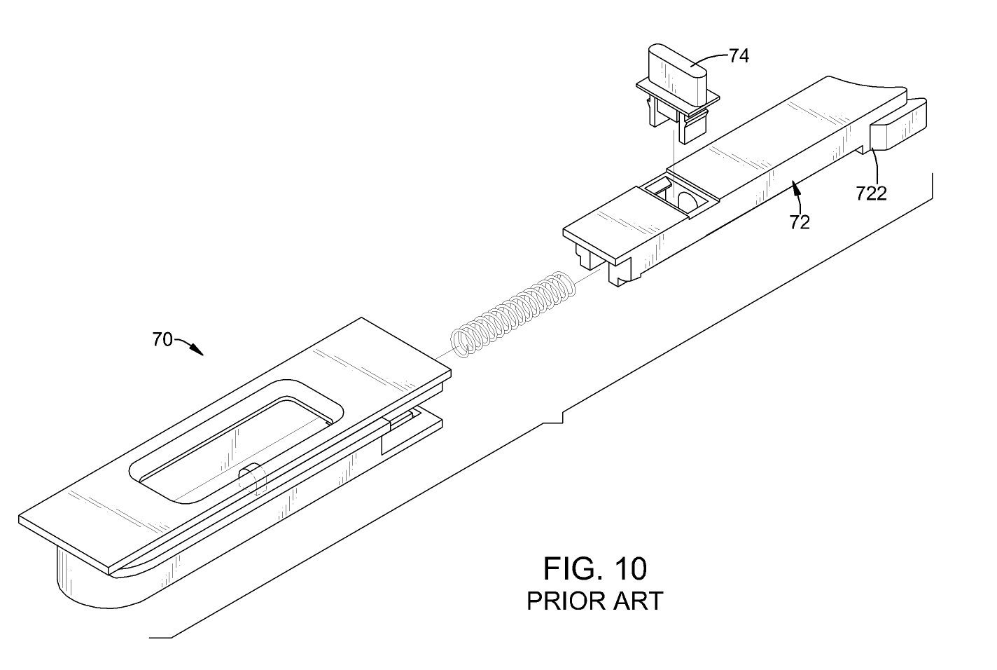

### DETAILED DESCRIPTION OF PREFERRED EMBODIMENT

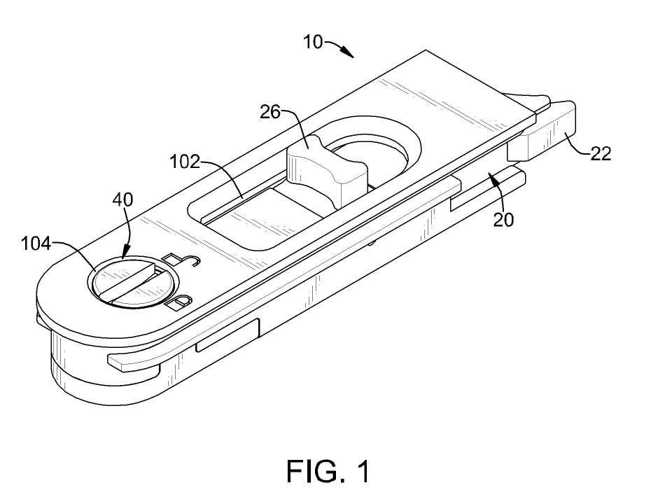

With reference to FIG. 1, a window tilt latch in accordance with the present invention comprises a casing (10), a latching bolt (20), a resilient element (30) and a safety device (40).

The casing (10) is hollow, is mounted on a top of a window and has a top, an open end, a guiding slot (102) and a knob hole (104). The guiding slot (102) is defined through the top of the casing (102). The knob hole (104) is defined through the top of the casing (102) at an end of the casing (10) opposite to the open end. In the preferred embodiment, the casing (10) is composed of a body (11) and a bottom cap (12). The body (11) is hollow, and the open end, the guiding slot (102) and the knob hole (104) are formed in the top of the body (11). The bottom cap (12) is attached detachably to the bottom of the body (11) and having a through hole (122) defined through the bottom cap (12) and aligning with the knob hole (104).

The latching bolt (20) is mounted slidably in the casing (10) and has a latching end (22), an inner end (24) and a sliding element (26). The latching end (22) is inclined, extends out of the open end of the casing (10) and engages a window frame to hold the window at a closed condition. The inner end (24) is opposite to the latching end (22) and is mounted in the casing (10). The inner end (24) of the latching bolt (20) may have an inserting rod (242) formed on and protruding from the inner end (24). The sliding element (26) is mounted detachably on the latching bolt (20) and is mounted slidably in the guiding slot (102). To detachably mount the sliding element (26) on the latching bolt (20), the latching bolt (20) has a holding hole (202) and two engaging slots (204). The holding hole (202) is defined through the top and the bottom of the latching bolt (20). The engaging slots (204) are defined in two sides of the latching bolt (20) and communicating with the holding hole (202). The sliding element (26) is mounted in the holding hole (202) and has two engaging hooks (262). The engaging hooks (262) are formed on and protrude from the sliding element (26) and engage respectively the engaging slots (204). With the engagement of the engaging hooks (262) with the engaging slots (204), the sliding element (26) is mounted detachably on the latching bolt (20). In addition, the casing (10) may further have two tool holes (106) defined in the casing (10) and aligning respectively with the engaging slots (204) in the latching bolt (20). Moreover, the casing (10) may further have a sliding slot (108) defined in/through the bottom of the casing (10). The sliding element (26) may further have a sliding tab (264) formed on and protruding from the bottom of the sliding element (26) between the engaging hooks (262) and slidably mounted in the sliding slot (108) in the casing (10). When the sliding element (26) is pushed, the sliding tab (264) can slide along the sliding slot (108) to make the latching bolt (20) moving relative to the casing (10) smoothly.

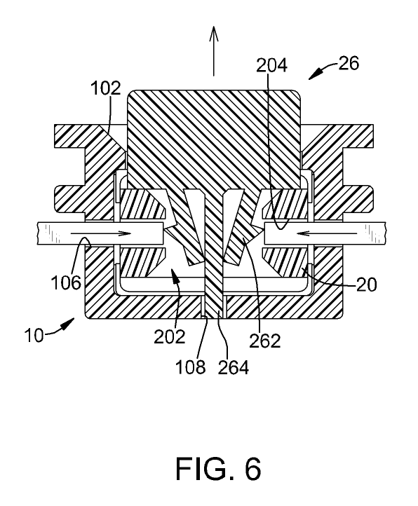

With further reference to FIG. 6, when tools are inserted into the tool holes (106) in the casing (10), the engaging hooks (262) on the sliding element (26) can be disengaged from the engaging slots (204) in the latching bolt (20). Consequently, the sliding element (26) can be detached from the latching bolt (20), and the latching bolt (20) can be then detached from the casing (10).

In addition, the latching bolt (20) has a central line (L) to divide the latching bolt (20) into two segments symmetrical to each other at the central line (L).

The resilient element (30) is mounted in the casing (10) and is connected to the latching bolt (20) to provide a recoil force to the latching bolt (20). In the preferred embodiment, the resilient element (30) is a spring, is mounted around the inserting rod (242) on the inner end (24) of the latching bolt (20) and has one end abutting with the inner end (24) of the latching bolt (20).

The safety device (40) is mounted on the casing (10) and comprises a control knob (42). The control knob (42) is mounted rotatably on the casing (10), abuts with one end of the resilient element (30) and abuts selectively with the inner end (24) of the latching bolt (20) to keep the latching bolt (20) from being retracted into the casing (10). The control knob (42) has a top, a bottom, an inserting hole (422), a tool slot (424) and a stub (426). The inserting hole (422) is defined in the control knob (42), may be diametrically through the control knob (42) and selectively aligns with the inner end (24) of the latching bolt (20). The tool recess (424) is defined in the top of the control knob (42) to allow the control knob (42) to be rotated with a tool, such as a screwdriver. The stub (426) is formed on and protrudes from the bottom of the control knob (42) and is mounted rotatably in the through hole (122) in the bottom cap (12).

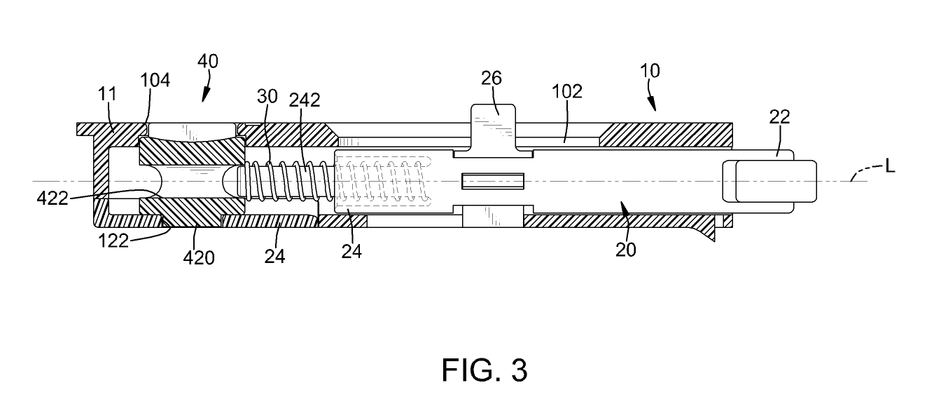

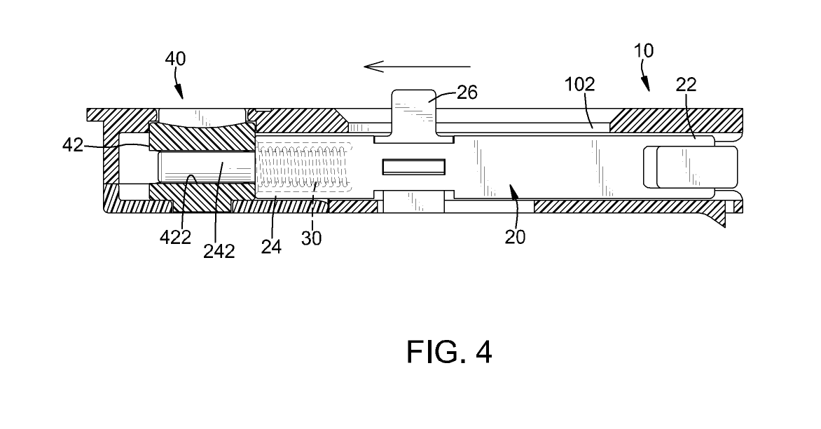

With reference to FIGS. 3 and 4, when the control knob (42) is rotated to a position where the inserting hole (422) aligns with the inserting rod (242) on the inner end (24) of the latching bolt (20), the latching bolt (20) is allowed to move relative to the casing (10) with the inserting rod (242) being inserted into the inserting hole (422). Consequently, a user can pulls the sliding element (26) to slide relative to the guiding slot (102), and the latching bolt (20) can be retracted into the casing (10) and disengaged from the window frame to unlock and open the window.

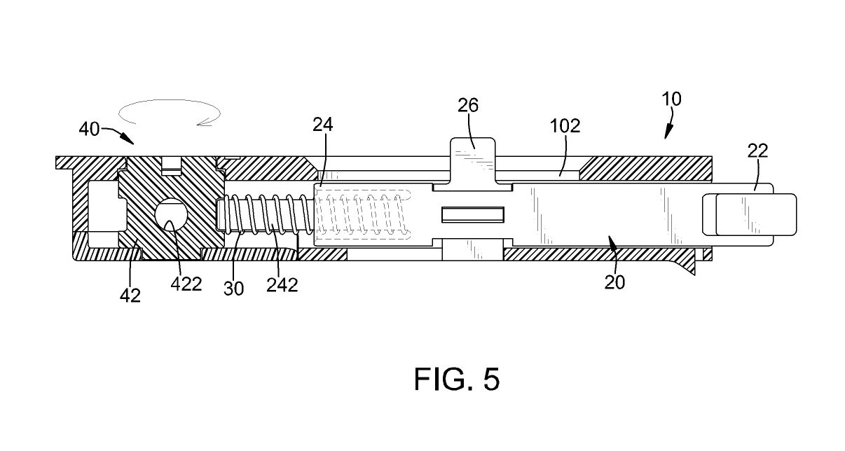

With reference to FIG. 5, when the control knob (42) is rotated to a position where the inserting hole (422) does not align with the inserting rod (242), the inserting rod (242) of the latching bolt (20) will abut against and be blocked by the control knob (42) to keep the latching bolt (20) from sliding relative to the casing (10). Accordingly, the window tilt latch will not be unlocked arbitrarily, and the window will not be opened unintentionally. This can improve the safety of using the window tilt latch and keep anyone from being injured unintentionally.

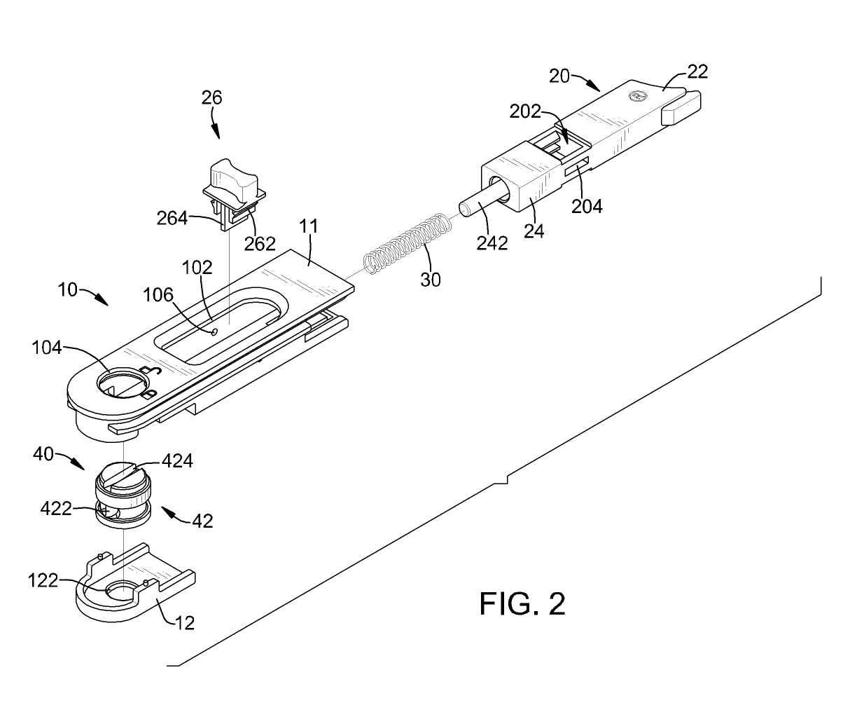

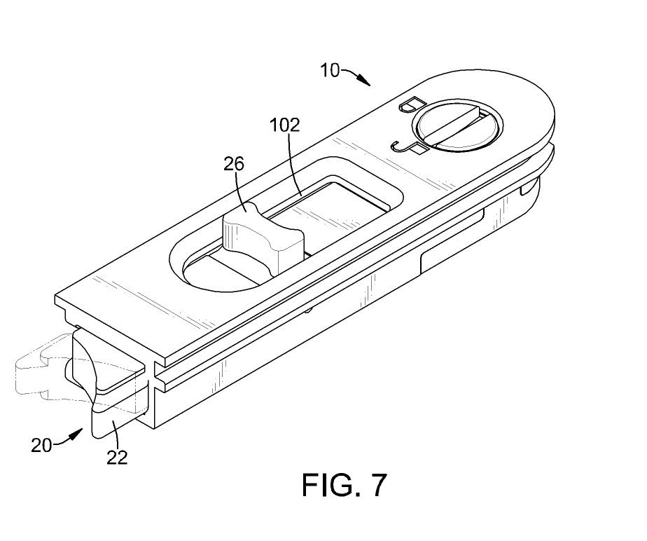

In addition, with reference to FIGS. 2, 3 and 7, because the latching bolt (20) has a symmetrical structure to a central line (L), the latching bolt (20) can be mounted in the casing (10) in two different directions as shown in the solid and phantom lines in FIG. 7. Accordingly, the window tilt latch in accordance with the present invention can be attached any side of a window with changing the mounting direction of the latching bolt (20), so another tilt latch having a latching bolt with a reversal latching end is unnecessary. Thus, the cost for manufacturing the window tilt latch can be efficiently reduced, and to assemble two window tilt latches with reversal latching ends onto a window is easy and convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A window tilt latch comprising:
a casing being hollow and having
a top;
an open end; and
a guiding slot defined in the top of the casing;
a latching bolt mounted slidably in the casing and having
a latching end extending out of the open end of the casing;
an inner end opposite to the latching end and mounted in the casing; and
a sliding element mounted on the latching bolt and mounted slidably in the guiding slot;
a resilient element mounted in the casing and connected to the latching bolt to provide a recoil force to the latching bolt; and
a safety device mounted on the casing and comprising a control knob mounted rotatably on the casing, selectively abutting with the inner end of the latching bolt to keep the latching bolt from being retracted into the casing and having
an inserting hole defined in the control knob and selectively aligning with the inner end of the latching bolt to allow the inner end of the latching bolt to be inserted into the inserting hole and to retract the latching end of the latching bolt into the casing.

2. The window tilt latch as claimed in claim 1, wherein the latching bolt has an inserting rod formed on and protruding from the inner end of the latching bolt to be inserted into the inserting hole in the control knob when the control knob is rotated to a position where the inserting hole aligns with the inserting rod.

3. The window tilt latch as claimed in claim 2, wherein the resilient element is a spring, is mounted around the inserting rod on the latching bolt and having two ends abutting respectively with the inner end of the latching bolt and the control knob.

4. The window tilt latch as claimed in claim 3, wherein
the latching bolt has
a holding hole defined through a top and a bottom of the latching bolt; and
two engaging slots defined in two sides of the latching bolt and communicating with the holding hole;
the sliding element is mounted in the holding hole in the latching bolt and has two engaging hooks formed on and protruding from the sliding element and engaging respectively the engaging slots in the latching bolt; and
the casing has two tool holes defined in the casing and aligning respectively with the engaging slots in the latching bolt.

5. The window tilt latch as claimed in claim 4, wherein the latching bolt has a central line to divide the latching bolt into two segments symmetrical to each other at the central line.

6. The window tilt latch as claimed in claim 5, wherein the casing further has a knob hole defined through the top of the casing at an end of the casing opposite to the open end; and
the control knob has a top mounted rotatably in the knob hole in the casing.

7. The window tilt latch as claimed in claim 6, wherein the control knob further has a tool recess defined in the top of the control knob.

8. The window tilt latch as claimed in claim 7, wherein
the casing is composed of
a hollow body in which the open end, the guiding slot and the knob hole of the casing are formed and having a bottom;
a bottom cap attached detachably to the bottom of the body and having a through hole defined through the bottom cap and aligning with the knob hole; and
the control knob further has a stub formed on and protruding from a bottom of the control knob and mounted rotatably in the through hole in the bottom cap.

9. The window tilt latch as claimed in claim 8, wherein
the casing further has a sliding slot defined in a bottom of the casing; and
the sliding element further has a sliding tab formed on and protruding from a bottom of the sliding element between the engaging hooks and slidably mounted in the sliding slot in the casing.

10. The window tilt latch as claimed in claim 1, wherein the resilient element is a spring, is mounted around the inner end of the latching bolt and having two ends abutting respectively with the latching bolt and the control knob.

11. The window tilt latch as claimed in claim 1, wherein
the latching bolt has
a holding hole defined through a top and a bottom of the latching bolt; and
two engaging slots defined in two sides of the latching bolt and communicating with the holding hole;
the sliding element is mounted in the holding hole in the latching bolt and has two engaging hooks formed on and protruding from the sliding element and engaging respectively the engaging slots in the latching bolt; and
the casing has two tool holes defined in the casing and aligning respectively with the engaging slots in the latching bolt.

12. The window tilt latch as claimed in claim 1, wherein the latching bolt has a central line to divide the latching bolt into two segments symmetrical to each other at the central line.

13. The window tilt latch as claimed in claim 1, wherein the casing further has a knob hole defined through the top of the casing at an end of the casing opposite to the open end; and
the control knob has a top mounted rotatably in the knob hole in the casing.

14. The window tilt latch as claimed in claim 13, wherein the control knob further has a tool recess defined in the top of the control knob.

15. The window tilt latch as claimed in claim 14, wherein
the casing is composed of
a hollow body in which the open end, the guiding slot and the knob hole of the casing are formed and having a bottom;
a bottom cap attached detachably to the bottom of the body and having a through hole defined through the bottom cap and aligning with the knob hole; and
the control knob further has a stub formed on and protruding from a bottom of the control knob and mounted rotatably in the through hole in the bottom cap.

16. The window tilt latch as claimed in claim 1, wherein
the casing further has a sliding slot defined in a bottom of the casing; and
the sliding element further has a sliding tab formed on and protruding from a bottom of the sliding element and slidably mounted in the sliding slot in the casing.
